(19) United States
(12) Patent Application Publication
(10) Pub. No.: US 2019/0073337 A1
(43) Pub. Date: Mar. 7, 2019

(54) APPARATUSES CAPABLE OF PROVIDING COMPOSITE INSTRUCTIONS IN THE INSTRUCTION SET ARCHITECTURE OF A PROCESSOR

(71) Applicant: MediaTek Singapore Pte. Ltd., Singapore (SG)

(72) Inventors: Liang XU, San Jose, CA (US); Ming-Chieh Kuo, San Jose, CA (US)

(21) Appl. No.: 16/120,645

(22) Filed: Sep. 4, 2018

Related U.S. Application Data
(60) Provisional application No. 62/554,052, filed on Sep. 5, 2017.

(51) Int. Cl. G06F 15/82; G06F 9/30

(52) U.S. Cl. CPC G06F 15/82; G06F 9/3001

(57) ABSTRACT

An apparatus includes multiple signal processing lanes and composite instruction controller. Each signal processing lane includes a first fundamental functional unit, a second fundamental functional unit and a register file unit having multiple configurable vector registers. The composite instruction controller is coupled to the first fundamental functional units and the second fundamental functional units in the plurality of signal processing lanes and is configured to issue control signals in response to a composite instruction to control the first fundamental functional units and the second fundamental functional units and thereby carry out a composite operation.

### CROSS REFERENCE TO RELATED APPLICATIONS

This application claims the benefit of U.S. Provisional Application No. 62/554,052 filed 2017 Sep. 5 and entitled “Composite Instructions in Vector DSP”, the entire contents of which are hereby incorporated by reference.

### BACKGROUND OF THE INVENTION

### Field of the Invention

The invention relates to a novel design to implement multiple composite instructions to support the corresponding common digital signal processing algorithms in a VD SP.

### Description of the Related Art

A Vector Digital Signal Processor (VDSP) is a type of efficient processor for implementing complex signal processing algorithms used in applications, such as wireless/wire line communication baseband processing, multi-media signal processing, etc. Conventional VDSPs support general purpose instructions, such as vector load, vector store, vector arithmetic (multiply, add, accumulation, min, max, etc.), and vector permutation (shift, move, etc.). VDSP may have multiple lanes to support parallel processing of multiple data samples in data vectors, and multiple functional units to support parallel execution of multiple instructions.

In applications such as the baseband signal processing in wireless or wire line communication systems, the software (or firmware) run on a VDSP normally needs to further support some common digital signal processing algorithms, e.g., Fast Fourier Transform (FFT), Finite Impulse Response (FIR) filtering, Correlation, etc. However, these common digital signal processing algorithms are not included in the vector Instruction Set Architecture (ISA) of the current VDSP.

To solve this problem, is a novel design to support these common digital signal processing algorithms in VDSP is proposed. In the proposed VDSP architecture design, a set of composite instructions configured to perform common digital signal processing algorithms, such as FFT, IFFT, FHT, FIR, correlation, etc., are implemented.

### BRIEF SUMMARY OF THE INVENTION

Apparatuses capable of providing composite instructions in the vector Instruction Set Architecture (ISA) of a processor are provided. An exemplary embodiment of an apparatus comprises a plurality of signal processing lanes and a composite instruction controller. Each signal processing lane comprises a first fundamental functional unit, a second fundamental functional unit, and a register file unit comprising a plurality of configurable vector registers. The composite instruction controller is coupled to the first fundamental functional units and the second fundamental functional units in the plurality of signal processing lanes, and is configured to issue a plurality of control signals in response to a composite instruction to control the first fundamental functional units and the second fundamental functional units and thereby carry out a composite operation.

An exemplary embodiment of an apparatus comprises a plurality of signal processing lanes and a first composite instruction controller. Each signal processing lane comprises a first fundamental functional unit, a second fundamental functional unit, and a register file unit. The first fundamental functional unit comprises a plurality of first buffers and a first computation unit. The second fundamental functional unit comprises a plurality of second buffers and a second computation unit. The register file unit comprises a plurality of configurable vector registers. The first composite instruction controller is configured to issue a plurality of control signals in response to a first composite instruction to control the plurality of first buffers and the first computation unit of the first fundamental functional units and the plurality of second buffers and the second computation unit of the second fundamental functional units in the plurality of signal processing lanes and thereby carry out a first composite operation.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A and FIG. 1B show an exemplary block diagram of an architecture of an apparatus capable of performing complex signal processing according to an embodiment of the invention;

FIG. 2 shows exemplary pseudo-codes to describe the operation control flow for performing the FFT operation via a 4-lane VDSP according to an embodiment of the invention;

FIG. 3 shows an exemplary block diagram of a composite functional unit capable of performing the FFT, IFFT and FHT operations according to an embodiment of the invention;

FIG. 4A is an exemplary block diagram of the butterfly unit according to an embodiment of the invention;

FIG. 4B is an exemplary block diagram of the butterfly unit according to another embodiment of the invention;

FIG. 5A is an exemplary block diagram of the butterfly unit according to yet another embodiment of the invention;

FIG. 5B is an exemplary block diagram of the butterfly unit according to yet another embodiment of the invention;

FIG. 6 shows exemplary pseudo-codes to describe the operation control flow for performing the FIR filtering without ramping operation via a 4-lane VDSP according to an embodiment of the invention;

FIG. 7 shows an exemplary block diagram of a composite functional unit capable of performing the FIR filtering with ramping and FIR filtering without ramping operations according to an embodiment of the invention;

FIG. 8A is a schematic diagram showing the operation of auto-correlation according to an embodiment of the invention;

FIG. 8B is a schematic diagram showing the operation of cross-correlation/vector multiplication according to an embodiment of the invention; and

FIG. 9 shows an exemplary block diagram of a composite functional unit capable of performing the auto-correlation, cross-correlation and vector multiplication operations according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Currently, there are two methods of implementing the common digital signal processing algorithms in a VDSP-based signal-processing system: 1) Software solution, and 2) Co-processor solution.

The software solution uses software functions or micro-codes to implement the algorithms. While the software implementation is flexible, the main drawbacks includes: 1-1) the performance, in terms of maximal data throughput per second when executing the algorithms, may not be optimal due to the functional limitation of general-purpose instructions and software control overhead, and 1-2) the code size may be large.

The co-processor solution is to implement a dedicated hardware module for each algorithm, and the dedicated hardware module is used as a co-processor to the VDSP. The main drawback of the co-processor solution is low utilization of hardware resources. Since each algorithm is implemented by a dedicated hardware co-processor, it's difficult to share hardware resource among different co-processors and with the VDSP.

In the following paragraphs, a novel design to support common digital signal processing algorithms in VDSP is proposed. In the proposed VDSP architecture, a set of composite instructions configured to perform common digital signal processing algorithms, such as FFT, IFFT, FHT, FIR, correlation, etc., are implemented. Unlike the software solution mentioned above, when using the composite instruction to realize common algorithms, the software code size can be reduced. In addition, due to reduction of the control overhead, better performance (higher data throughput) can be achieved. In addition, unlike the co-processor solution mentioned above, when using the composite instructions to realize common algorithms, higher utilization of the hardware resources can be achieved.

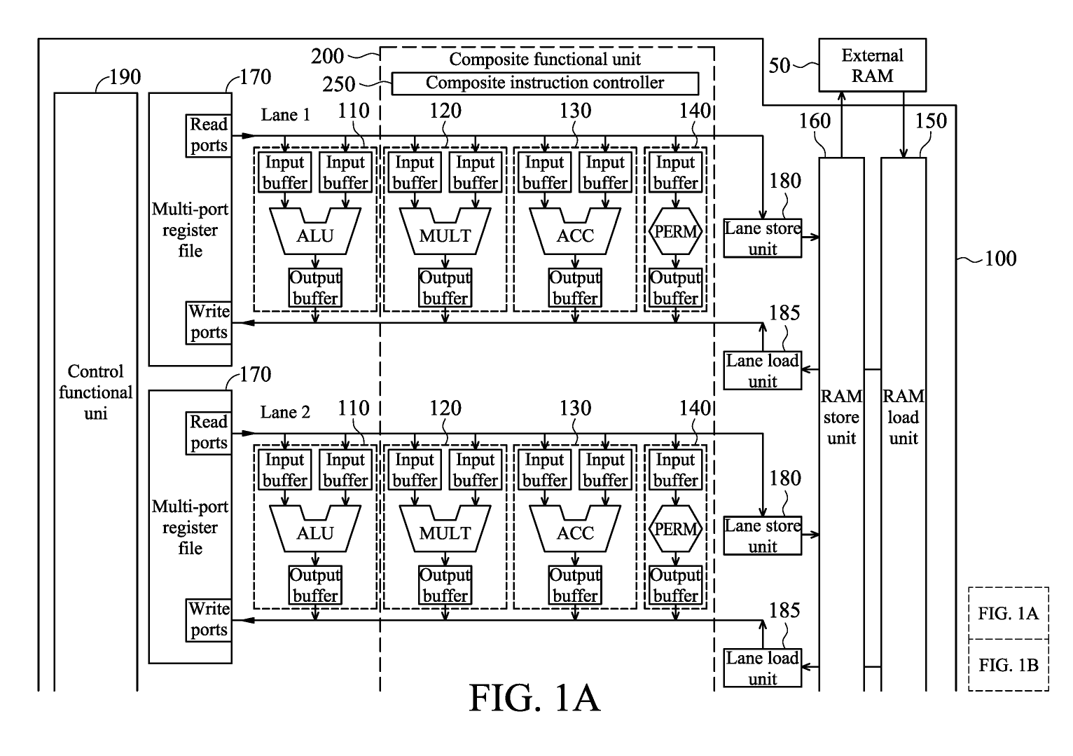

FIG. 1A and FIG. 1B show an exemplary block diagram of an architecture of an apparatus capable of performing complex signal processing according to an embodiment of the invention. It should be noted that in order to clarify the concept of the invention, FIG. 1A and FIG. 1B present a simplified block diagram, in which only the elements relevant to the invention are shown. However, the invention should not be limited only to what is shown in FIG. 1A and FIG. 1B.

According to an embodiment, the apparatus 100 may be a vector digital signal processor (VDSP) that can support a plurality of complex signal processing algorithms. The apparatus 100 comprises a plurality of signal processing lanes, such as the Lane 1, Lane 2, Lane 3 and Lane 4 as shown in FIG. 1A and FIG. 1B. Noted that although there are four signal processing lanes shown in FIG. 1A and FIG. 1B, the invention should not be limited thereto. The apparatus 100 may also comprise less than 4 or more than 4 signal processing lanes.

Each signal processing lane may comprise a plurality of fundamental functional units, such as one or more adder functional units 110, one or more multiplier functional units 120, one or more accumulation functional units 130, one or more permutation functional units 140, . . . etc. Each fundamental functional unit is configured to support a general-purpose instruction by carrying out a corresponding fundamental operation. The adder functional unit 110 is configured to carry out an addition operation in response to an add (e.g., vector-add (vAdd)) instruction. The multiplier functional unit 120 is configured to carry out a multiplication operation in response to a multiply (e.g., vector-multiply (vMult)) instruction. The accumulation functional unit 130 is configured to carry out an accumulation operation in response to an accumulate (e.g., vector-accumulate (vAcc)) instruction. The permutation functional unit 140 is configured to carry out a permutation operation in response to a permutation (e.g., vector-permutation (vShift) for shifting the data elements of a vector) instruction. As an example, the apparatus 100 receives the instructions and data that have been input via a corresponding interface, and then triggers the corresponding functional units to perform the corresponding operations.

Each fundamental functional unit may comprise a plurality of buffers and a corresponding computation unit. The adder functional unit 110 may comprise two input buffers for receiving two operands, a computation unit ALU for performing the addition operation and an output buffer for outputting the calculation result. The multiplier functional unit 120 may comprise two input buffers for receiving two operands, a computation unit MULT for performing the multiplication operation and an output buffer for outputting the calculation result. The accumulation functional unit 130 may comprise two input buffers for receiving two operands, a computation unit ACC for performing the accumulation operation and an output buffer for outputting the calculation result. The permutation functional unit 140 may comprise an input buffer for receiving input data, a computation unit PERM for performing the permutation operation and an output buffer for outputting the permutation result.

The apparatus 100 further comprise a RAM load unit 150, a RAM store unit 160, a plurality of register file units, such as the multi-port register file units 170, a plurality of lane store units 180, a plurality of lane load units 185 and a control functional unit 190. The RAM load unit 150 is configured to load data from an external RAM 50 in response to a corresponding load instruction. The RAM store unit 160 is configured to store data (the results output by the fundamental functional units) into the external RAM 50 in response to a corresponding store instruction. A multi-port register file unit 170 is disposed in each signal processing lane and comprises a plurality of configurable registers and vector registers provided for the fundamental functional units in the same signal processing lane to buffer data. A lane store unit 180 is disposed in each signal processing lane and is configured to provide data to be stored into the external RAM 50 to the RAM store unit 160. A lane load unit 185 is disposed in each signal processing lane and is configured to load data from the RAM load unit 150. The control functional unit 190 is configured to perform scalar operations. Compared to the scalar operations, the vector-wise operations can be carried out via the fundamental functional units in multiple signal processing lanes.

As discussed above, a fundamental functional unit is configured to carry out a corresponding fundamental operation in response to a corresponding instruction (i.e. the general-purpose instruction). When performing the corresponding fundamental operation, the fundamental functional unit may access the data stored in the registers of the multi-port register file unit 170 via the read ports, so as to load the data into the input buffer(s) thereof, perform the corresponding fundamental operation on the data, and store the result into the output buffer thereof. The output data may be stored into the corresponding registers of the multi-port register file unit 170 via the write ports. Each fundamental functional unit may further comprise a dedicated controller for controlling the operation flow.

FIG. 1A and FIG. 1B show only a portion of hardware devices for processing the data received by the apparatus 100. Regarding the processing of received instruction, the apparatus 100 may further comprise an instruction fetch unit (not shown) configured to fetch input instruction, an instruction memory (not shown) configured to store the received instructions, an instruction decode unit (not shown) configured to decode the received instructions, an instruction dispatch unit (not shown) configured to dispatch the instruction to the corresponding controller of each functional unit, and other control logics for processing the received instruction.

According to an embodiment of the invention, besides the fundamental functional units discussed above, the apparatus 100 may further comprise one or more composite functional units, such as the composite functional unit 200 shown in FIG. 1A and FIG. 1B. In the embodiments of the invention, the composite functional units may use the fundamental functional units configured in multiple signal processing lanes to carry out a corresponding composite operation. To be more specific, multiple lanes of the same fundamental functional unit may be grouped to a composite functional unit to support the common digital signal processing algorithm as discussed above. Each composite functional unit may comprise a composite instruction controller, such as the composite instruction controller 250 shown in FIG. 1A and FIG. 1B. The composite instruction controller 250 may be coupled to one or more fundamental functional units in the plurality of processing lanes. In response to a composite instruction received by the apparatus 100 and, after being decoded, dispatched to the composite instruction controller 250, the composite instruction controller 250 is configured to issue a plurality of control signals to control the fundamental functional units to perform their corresponding operations, so as to carry out the corresponding composite operation.

It should be noted that, unlike the co-processor design, in the embodiments of the invention, the buffers and the corresponding computation units of the fundamental functional units are shared with at least one composite functional unit, such as the composite functional unit 200. In addition, in the embodiments of the invention, the buffers and the corresponding computation units of the fundamental functional units may be further shared among multiple composite functional units. In addition, in the embodiments of the invention, the vector registers, control registers, other general-purpose registers such as scalar data registers, instruction decode and dispatch pipeline of the apparatus 100 may also be shared among different functional units, including the fundamental functional units and the composite functional units. Since the hardware resources of the apparatus 100 can be shared among different functional units, including the fundamental functional units and the composite functional units, higher utilization of hardware resources can be achieved.

According to an embodiment of the invention, the composite operation carried out by the composite functional unit, such as the composite functional unit 200, may be selected from a group comprising a Fast Fourier Transform (FFT), an inverse Fast Fourier Transform (iFFT), a Fast Hadamard Transform (FHT), a Finite Impulse Response (FIR) filtering with ramping, an FIR filtering without ramping, an auto-correlation, a cross-correlation and a vector multiplication. Therefore, a set of composite instructions supporting common digital signal processing algorithms can be added as part of the vector Instruction Set Architecture (ISA) of the apparatus 100 (e.g. the VDSP), and can be provided for the VDSP user to use them directly (that is, the VDSP user can directly input the corresponding instruction to perform the corresponding calculation).

In addition, in the embodiments of the invention, one composite functional unit may be configured to carry out multiple composite operations with similar computation procedure. The composite functional units and their corresponding composite operations will be illustrated in more detailed in the following paragraphs.

According to a first embodiment of the invention, a composite functional unit may be configured to perform the FFT, IFFT and FHT operations.

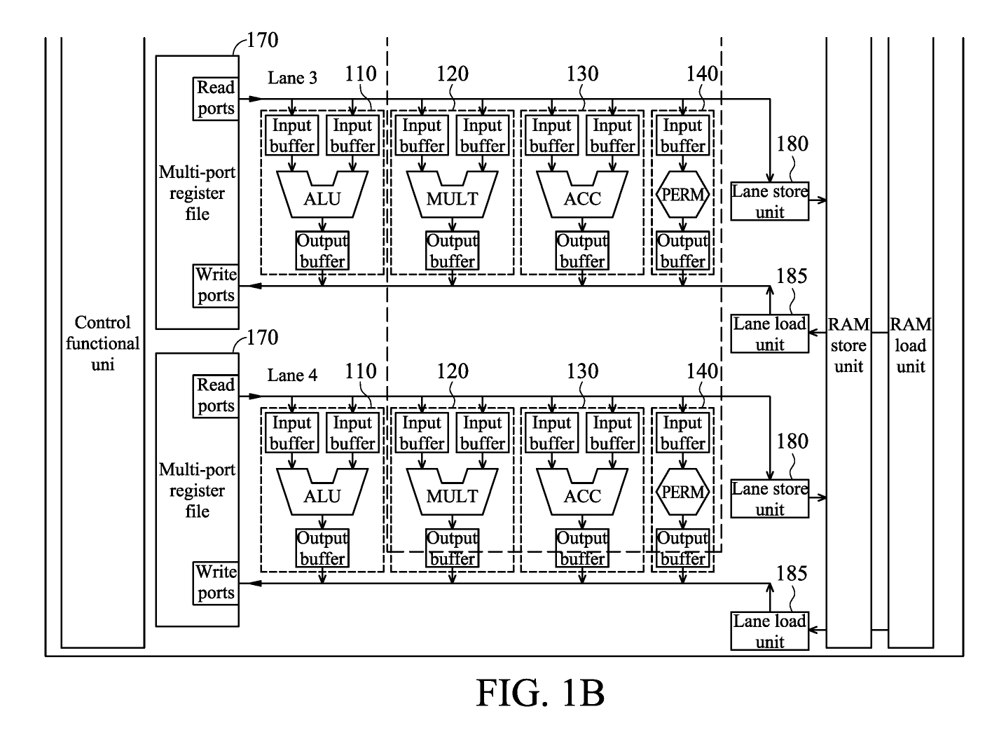

FIG. 2 shows exemplary pseudo-codes to describe the operation control flow for performing the FFT operation via a 4-lane VD SP according to an embodiment of the invention. It should be noted that it can be easily extended to the VDSP with any number of lanes.

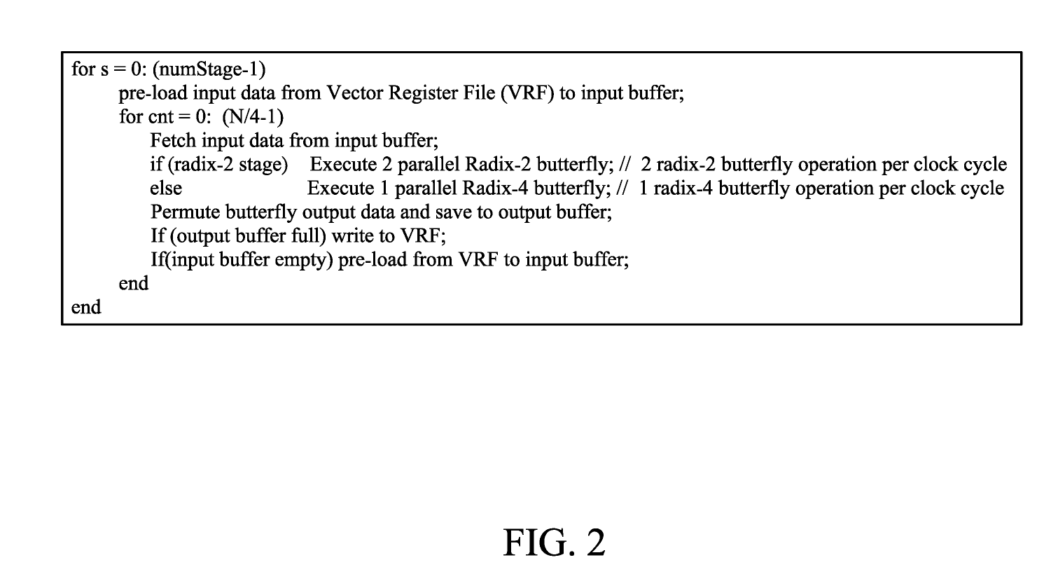

FIG. 3 shows an exemplary block diagram of a composite functional unit capable of performing the FFT, IFFT and FHT operations according to an embodiment of the invention. Accompanying FIG. 2 with FIG. 3, the FFT/IFFT/FHT operations that can be carried out by the composite functional unit 300 are illustrated in more detail in the following paragraphs.

According to an embodiment of the invention, the ways to utilize the FFT, IFFT, and FHT instructions based on radix-2 or radix-4 FFT/IFFT/FHT algorithm are provided below:

FFT Vr_dest, Vr_src, Rctrl

IFFT Vr_dest, Vr_src, Rctrl

FHT Vr_dest, Vr_src, Rctrl

The input parameter Vr_dest is the name of a destination vector register, the input parameter Vr_src is the name of a source vector register and the input parameter Rctrl is the name of a control register used to specify the size of vector register (i.e., the number of samples in one vector register) to be processed by FFT or IFFT or FHT. The destination Vector register, source vector register and control register are the register/vector registers in the multi-port register file unit 170.

As shown in FIG. 3, the instruction decode and dispatch unit 60 may decode the instructions received by the apparatus 100, and dispatch the decoded result to the corresponding functional unit. In this embodiment, the instruction decode and dispatch unit 60 may provide the control signals: fft_start, op_code and vector_length to the controller (the composite instruction controller) 310. The control signal fft_start indicates start of the corresponding operation. The control signal op_code indicates which operation of the FFT, IFFT and FHT is to be performed and further indicates the names of the registers to be accessed. The control signal vector_length indicates the length of the vector to be processed.

The input data is loaded from the external RAM 50 and then stored in the vector register file (VRF) 340 via the load unit 320. The output data is loaded from vector register file (VRF) 340 and then stored in the external RAM 50 via the store unit 330. It should be noted that in FIG. 3, the load unit 320 represents a combination of the functions of the RAM load unit 150 and the lane load unit 185 for simplicity. Similarly, the store unit 330 represents a combination of the functions of the RAM store unit 160 and the lane store unit 180 for simplicity. The vector register file (VRF) 340 represents the vector registers, which are configured to facilitate performance of the FFT/IFFT/FHT operation via the instruction, in the multi-port register file 170 for simplicity.

The FFT/IFFT/FHT instructions use hardware resources in multiplier, accumulation, and permutation functional units. The controller 310 is configured to generate control signals to conduct the data flow of the FFT, the IFFT and the FHT instructions based on the operation procedures required by FFT/IFFT/FHT algorithms. The controller 310 comprises an FFT/IFFT/FHT operation control unit 311, an input data address generation unit 312, an output data address generation unit 313, a twiddle look-up table address generation unit 314 and an output data permutation control unit 315. The FFT/IFFT/FHT operation control unit 311 is configured to issue the control signals for controlling operations of the fundamental functional units, so as to control the multi-stage FFT/IFFT/FHT operation based on Decimation-in-Frequency (DIF) or Decimation-in-Time (DIT) or a mixed DIF/DIT FFT or FHT algorithm. The input data address generation unit 312 is configured to generate an input data address for fetching data from the vector register file (VRF) 340 (i.e. the multi-port register file unit) based on the register name carried in the control signal op_code and providing fetched data to the input buffers of the corresponding functional units. The output data address generation unit 313 is configured to generate an output data address for storing data fetched from the output buffers of the corresponding functional units to the vector register file (VRF) 340 (i.e. the multi-port register file unit) based on the register name carried in the control signal op_code. That is, the vector register file (VRF) 340 is configured to hold the source and destination data vector registers for the FFT/IFFT/FHT instructions.

The twiddle look-up table address generation unit 314 is configured to generate the address of the Twiddle factor look-up table (LUT) 305. The Twiddle factor LUT 305 is configured to store the twiddle factors. The output data permutation control unit 315 is configured to generate a plurality of permutation control signals to utilize the permutation functional unit for re-ordering output data of the butterfly unit 400 as required by the FFT/IFFT/FHT algorithms. The butterfly unit 400 is configured perform butterfly operations

As per the operation control flow shown by the pseudo-code in FIG. 2, the controller 310 issues the read request (e.g. the VRF Rd Req) and provides the read address (e.g. the VRF Rd Addr) to preload the input data from the vector register file (VRF) 340 to the input buffers of the accumulation functional units 130 (shown as the input buffers (ACC functional unit) 350 in FIG. 3) and the input buffers of the multiplier functional units 120 (shown as the input buffers (MULT functional unit) 360 in FIG. 3). The input buffers inside the ACC/MULT/PERM functional units are configured to hold the input data to FFT/IFFT/FHT butterfly unit 400. Next, the input data is fetched from the input buffers (ACC functional unit) 350 and the input buffers (MULT functional unit) 360 and provided to the butterfly unit 400. The butterfly unit 400 is configured to perform radix-2 or radix-4 parallel butterfly operation. It is to be noted that the parameter numStage in the pseudo-code represents the number of stage of the FFT operation, and the parameter N represents the length of the data samples for the FFT operation. The output data of the butterfly unit 400 is provided to the output buffers of the permutation functional unit 140 (shown as the output buffers (PERM functional unit) 370 in FIG. 3). The output data of the PERM functional unit is further provided to the output buffers of the multiplier functional units 120 (shown as the output buffers (MULT functional unit) 380 in FIG. 3) and the output buffers of the accumulation functional units 130 (shown as the output buffers (ACC functional unit) 390 in FIG. 3). The output buffers inside the ACC/MULT/PERM functional units are configured to hold the output data to be saved back to vector register file (VRF) 340. If the output buffer is full, the controller 310 issues the write request (e.g. the VRF Wr Req) and provides the write address (e.g. the VRF Wr Addr) to write the output data to the vector register file (VRF) 340.

It should be noted that in the embodiments of the invention, the FFT/IFFT/FHT instructions can be executed in parallel with other normal (i.e. non-composite, or named general-purpose) instructions such as load and store instructions.

According to an embodiment of the invention, at least part of the fundamental functional units, either in the same lane or in different lanes, are controlled by the composite instruction controller to carry out a butterfly operation that is required for the composite operation. The butterfly operation may be a radix-2 butterfly operation or a radix-4 butterfly operation. Several exemplary designs of the butterfly unit are illustrated in the following paragraphs.

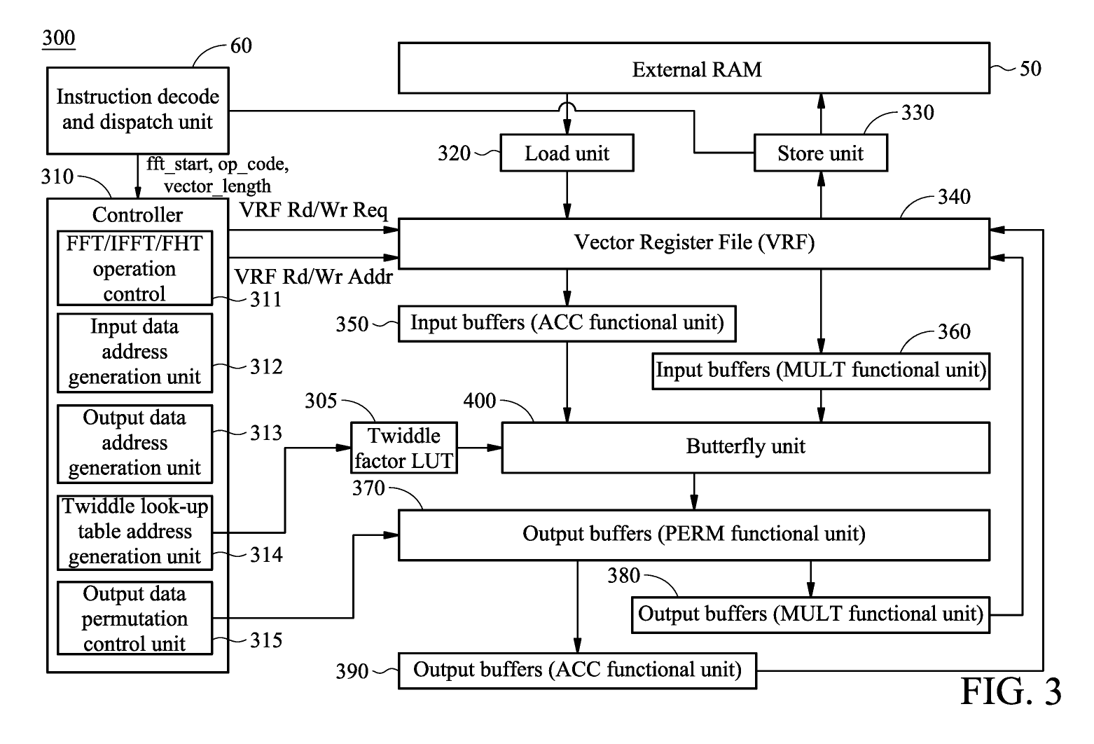

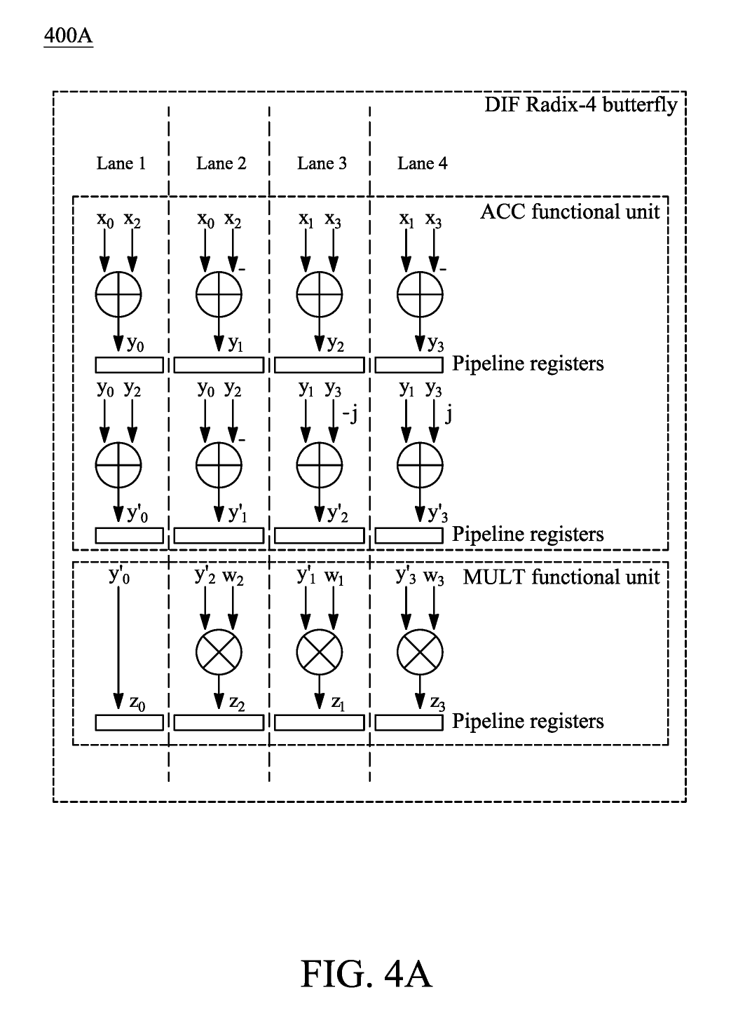

FIG. 4A is an exemplary block diagram of the butterfly unit according to an embodiment of the invention. In FIG. 4A, the butterfly unit 400A is configured to execute the Decimate-in-frequency (DIF) Radix-4 butterfly operations, where the x0˜x3, y0˜y3 and y′0˜y′3 represent the input/output data, the w1˜w3 represent twiddle factors, and the z0˜z3 represent the output data. As shown in FIG. 4A, the butterfly unit 400A uses 8 complex adders and 3 complex multipliers for the multiplications of twiddle factors. Noted that the multipliers and Twiddle factors are not used by FHT instructions. The butterfly unit 400A uses four lanes of multiplier functional units 120 and accumulation functional units 130. The output of the accumulation functional units 130 and multiplier functional units 120 are provided to the pipeline registers of the corresponding signal processing lane. It should be noted that both the adder functional unit 110 and the accumulation functional unit 130 comprise the adders as their hardware resources. Therefore, the butterfly unit 400A may also be designed to use four lanes of multiplier functional units 120 and adder functional units 110, and the invention should not be limited to any specific method of implementation.

It should be noted that in the architecture shown in FIG. 4A, the butterfly unit 400A has a cross-lane architecture, that is, the output data of fundamental functional unit in one lane is provided as the input data of the fundamental functional unit in another lane. As an example, the output data y1 of the accumulation functional unit 130 in lane 2 is provided as the input data of the accumulation functional unit 130 in lane 3.

FIG. 4B is an exemplary block diagram of the butterfly unit according to another embodiment of the invention. In FIG. 4B, the butterfly unit 400B is configured to execute the DIF Radix-2 butterfly operations, where the x0˜x1 and y0˜y1 represent the input/output data, the w1 represents twiddle factor, and the z0˜z1 represent the output data. As shown in FIG. 4B, the butterfly unit 400B uses 2 complex adders and 1 complex multiplier for the multiplications of twiddle factor. Noted that the multipliers and Twiddle factor are not used by FHT instructions. The butterfly unit 400B uses two lanes of multiplier functional units 120 and accumulation functional units 130. The output of the accumulation functional units 130 and multiplier functional units 120 are provided to the pipeline registers of the corresponding signal processing lane. It should be noted that the butterfly unit 400B may also be designed to use two lanes of multiplier functional units 120 and adder functional units 110, and the invention should not be limited to any specific method of implementation.

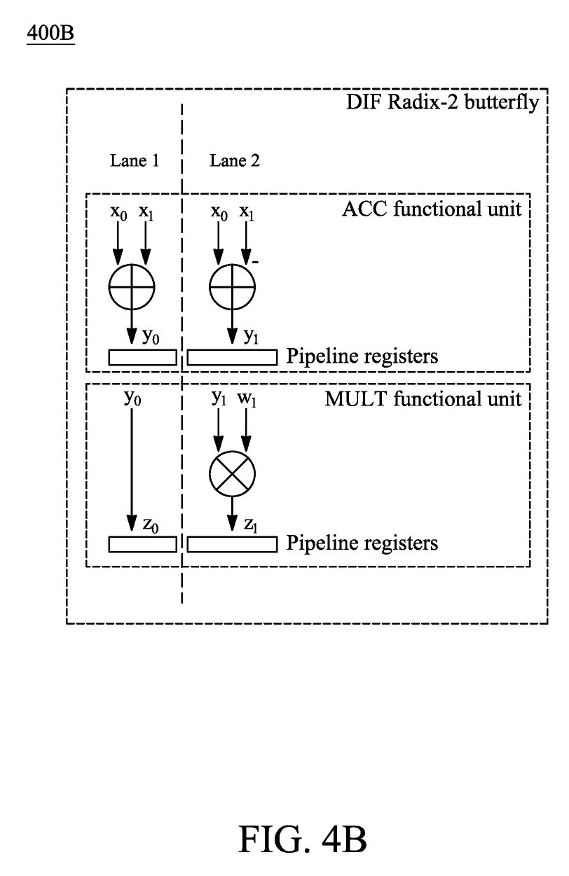

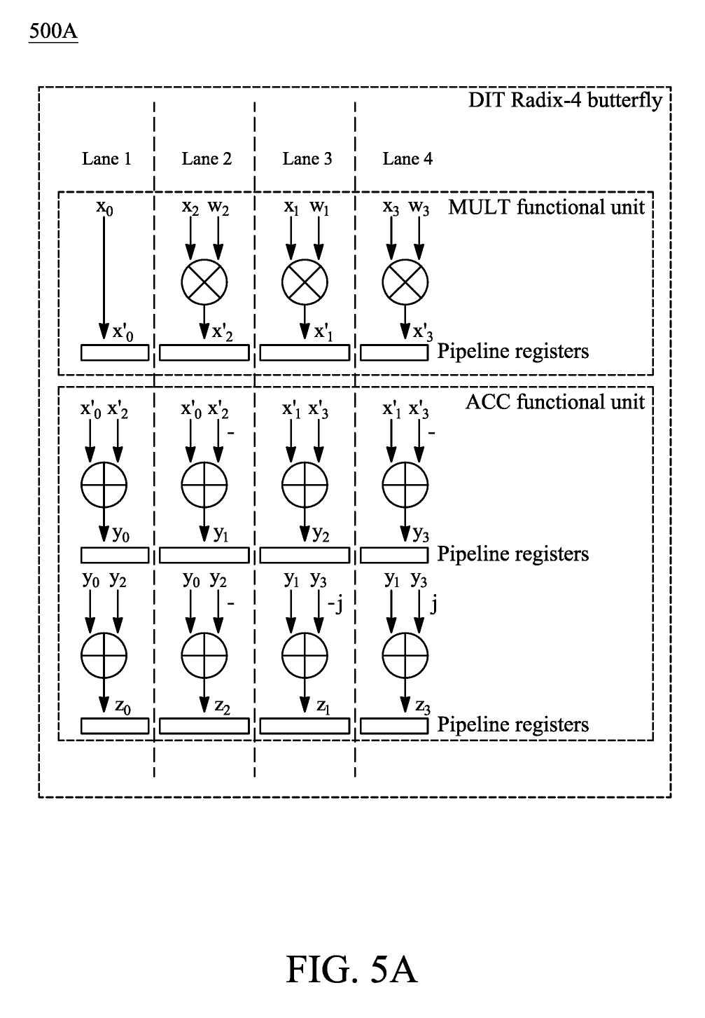

FIG. 5A is an exemplary block diagram of the butterfly unit according to yet another embodiment of the invention. In FIG. 5A, the butterfly unit 500A is configured to execute the Decimate-in-time (DIT) Radix-4 butterfly operations, where the x0˜x3, x′0˜x′3 and y0˜y3 represent the input/output data, the w1˜w3 represent twiddle factors, and the z0˜z3 represent the output data. As shown in FIG. 5A, the butterfly unit 500A uses 8 complex adders and 3 complex multipliers for the multiplications of twiddle factors. The butterfly unit 500A uses four lanes of multiplier functional units 120 and accumulation functional units 130. The output of the accumulation functional units 130 and multiplier functional units 120 are provided to the pipeline registers of the corresponding signal processing lane. It should be noted that the butterfly unit 500A may also be designed to use four lanes of multiplier functional units 120 and adder functional units 110, and the invention should not be limited to any specific method of implementation.

It should be noted that in the architecture shown in FIG. 5A, the butterfly unit 500A has a cross-lane architecture, that is, the output data of fundamental functional unit in one lane is provided as the input data of the fundamental functional unit in another lane. As an example, the output data x′2 of the multiplier functional units 120 in lane 2 is provided as the input data of the accumulation functional unit 130 in lane 1.

FIG. 5B is an exemplary block diagram of the butterfly unit according to yet another embodiment of the invention. In FIG. 5B, the butterfly unit 500B is configured to execute the DIT Radix-2 butterfly operations, where the x0˜x1 and y0˜y1 represent the input/output data, the w1 represents twiddle factor, and the z0˜z1 represent the output data. As shown in FIG. 5B, the butterfly unit 500B uses 2 complex adders and 1 complex multiplier for the multiplications of twiddle factor. The butterfly unit 500B uses two lanes of multiplier functional units 120 and accumulation functional units 130. The output of the accumulation functional units 130 and multiplier functional units 120 are provided to the pipeline registers of the corresponding signal processing lane. It should be noted that the butterfly unit 500B may also be designed to use two lanes of multiplier functional units 120 and adder functional units 110, and the invention should not be limited to any specific method of implementation.

According to a second embodiment of the invention, a composite functional unit may be configured to perform the FIR filtering with ramping and FIR filtering without ramping operations.

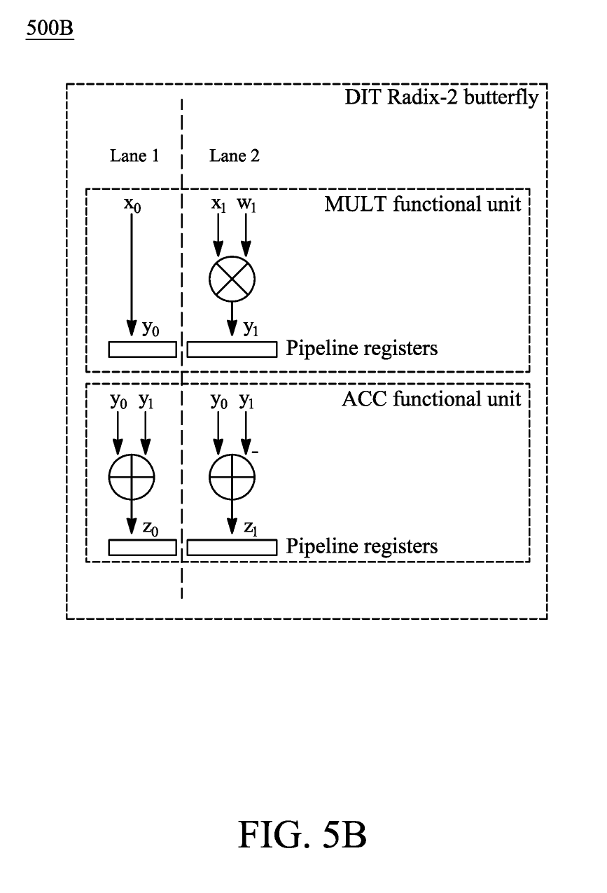

FIG. 6 shows exemplary pseudo-codes to describe the operation control flow for performing the FIR filtering without ramping operation via a 4-lane VDSP according to an embodiment of the invention. It should be noted that it can be easily extended to the VDSP with any number of lanes.

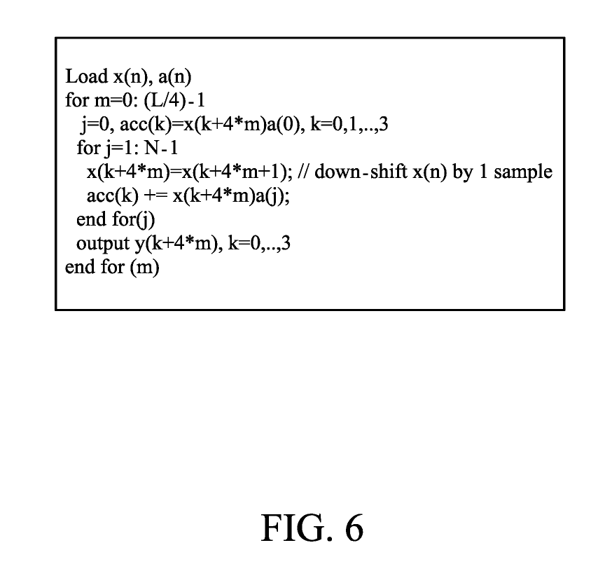

FIG. 7 shows an exemplary block diagram of a composite functional unit capable of performing the FIR filtering with ramping and FIR filtering without ramping operations according to an embodiment of the invention. Accompanying FIG. 6 with FIG. 7, the FIR filtering with ramping and FIR filtering without ramping operations that can be carried out by the composite functional unit 700 are illustrated in more detail in the following paragraphs.

According to an embodiment of the invention, the ways to utilize the FIR with/without ramping instructions are provided below:

Fir Vr_dest, Vr_src1, Vr_src2, Rctrl

FirNoRamp Vr_dest, Vr_src1, Vr_src2, Rctrl

The Fir is the instruction to support FIR with ramping, and the FirNoRamp is the instruction to support FIR without ramping.

The input parameter Vr_dest is the name of a destination vector register that holds the output data of the FIR filter, the input parameter Vr_src1 is the name of a source vector register that holds the input data to the FIR filter, the input parameter Vr_src2 is the name of a source vector register that holds the coefficients of the FIR filter and the input parameter Rctrl is the name of a control register used to specify the lengths of the input data vector and coefficient vector. The destination Vector register, source vector registers and control register are the register/vector registers in the multi-port register file unit 170.

As shown in FIG. 7, the instruction decode and dispatch unit 60 may decode the instructions received by the apparatus 100, and dispatch the decoded result to the corresponding functional unit. In this embodiment, the instruction decode and dispatch unit 60 may provide the control signals: fir_start, op_code and vector_length to the controller (the composite instruction controller) 710. The control signal fir_start indicates start of the corresponding operation. The control signal op_code indicates which operation of the FIR and FIR without ramping is to be performed and further indicates the names of the registers to be accessed. The control signal vector_length indicates the length of the vector to be processed.

The input data is loaded from the external RAM 50 and then stored in the vector register file (VRF) 740 via the load unit 720. The output data is loaded from vector register file (VRF) 740 and then stored in the external RAM 50 via the store unit 730. It should be noted that, in FIG. 7, the load unit 720 represents a combination of the functions of the RAM load unit 150 and the lane load unit 185 for simplicity. Similarly, the store unit 730 represents a combination of the functions of the RAM store unit 160 and the lane store unit 180 for simplicity. The vector register file (VRF) 740 represents the vector registers, which are configured to facilitate performance of the FIR or FIR without ramping operation via the instruction, in the multi-port register file 170 for simplicity.

The FIR related instructions use hardware resources in multiplier, accumulation, and permutation functional units. The controller 710 is configured to generate control signals to conduct the data flow of the Fir and FirNoRamp instructions based on the operation procedures required by FIR and FIR without ramping algorithms. The controller 310 comprises an Fir/FirNoRamp operation control unit 711, an input data address generation unit 712, an output data address generation unit 713 and an input data shift control unit 714. The Fir/FirNoRamp operation control unit 711 is configured to issue the control signals for controlling operations of the fundamental functional units, so as to control the FIR operation with or without ramping. The input data address generation unit 712 is configured to generate an input data address for fetching data from the vector register file (VRF) 740 (i.e. the multi-port register file unit) based on the register name carried in the control signal op_code and providing fetched data to the input buffers of the corresponding functional units. The output data address generation unit 713 is configured to generate an output data address for storing data fetched from the output buffers of the corresponding functional units to the vector register file (VRF) 740 (i.e. the multi-port register file unit) based on the register name carried in the control signal op_code. That is, the vector register file (VRF) 740 is configured to hold the source and destination data vector registers for the Fir/FirNoRamp instructions. The input data shift control unit 714 is configured to generate a plurality of shift control signals to shift input data vector for supporting the FIR algorithm.

The FIR instruction (Fir) is to calculate:

y(k)=Σⱼ₌₀^{N-1}x(k−j)a(N−j−1), k=0,1, . . . ,(L+N−2)

The FIR instruction without ramping (FirNoRamp) to calculate:

y(k)=Σⱼ₌₀^{N-1}x(k+j)a(j), k=0,1, . . . ,(L−N)

The x(k) represents the input data, the a(j) represents the coefficients, the y(k) represents the FIR result, the L represents the length of the data vector and the N represents the length of the filter.

As per operation control flow shown by the pseudo-code in FIG. 6, the controller 710 issues the read request (e.g. the VRF Rd Req) and provides the read address (e.g. the VRF Rd Addr) to load the input data and the coefficients from the vector register file (VRF) 740 to the input buffers of the permutation functional units 140 (shown as the input buffers (PERM functional unit) 750 in FIG. 7) and the input buffers of the multiplier functional units 120 (shown as the input buffers (MULT functional unit) 770 in FIG. 7). The input data is loaded to the input buffers (PERM functional unit) 750, and the coefficients are loaded to the input buffers (MULT functional unit) 770. The input data shifter of the permutation functional units 140 (shown as the input data shifter (PERM functional unit) 760 in FIG. 7) is configured to perform the down-shift operation on the input data. The shifted input data is multiplied by the coefficients via the multiplier functional units 120 and the output data of the multiplier functional units 120 is then provided to the accumulation functional units 130 via the pipeline registers 780. The accumulation functional units 130 perform the accumulation calculations on the received data and store the calculation result in the output buffers thereof (shown as the output buffers (ACC functional unit) 790 in FIG. 7). The output buffers inside the ACC functional units are configured to hold the output data to be saved back to vector register file (VRF) 740. The controller 710 issues the write request (e.g. the VRF Wr Req) and provides the write address (e.g. the VRF Wr Addr) to write the output data to the vector register file (VRF) 740.

It should be noted that in the embodiments of the invention, the Fir/FirNoRamp instructions can be executed in parallel with other normal (non-composite) instructions such as load and store instructions.

According to a third embodiment of the invention, a composite functional unit may be configured to perform the auto-correlation, cross-correlation and vector multiplication operations.

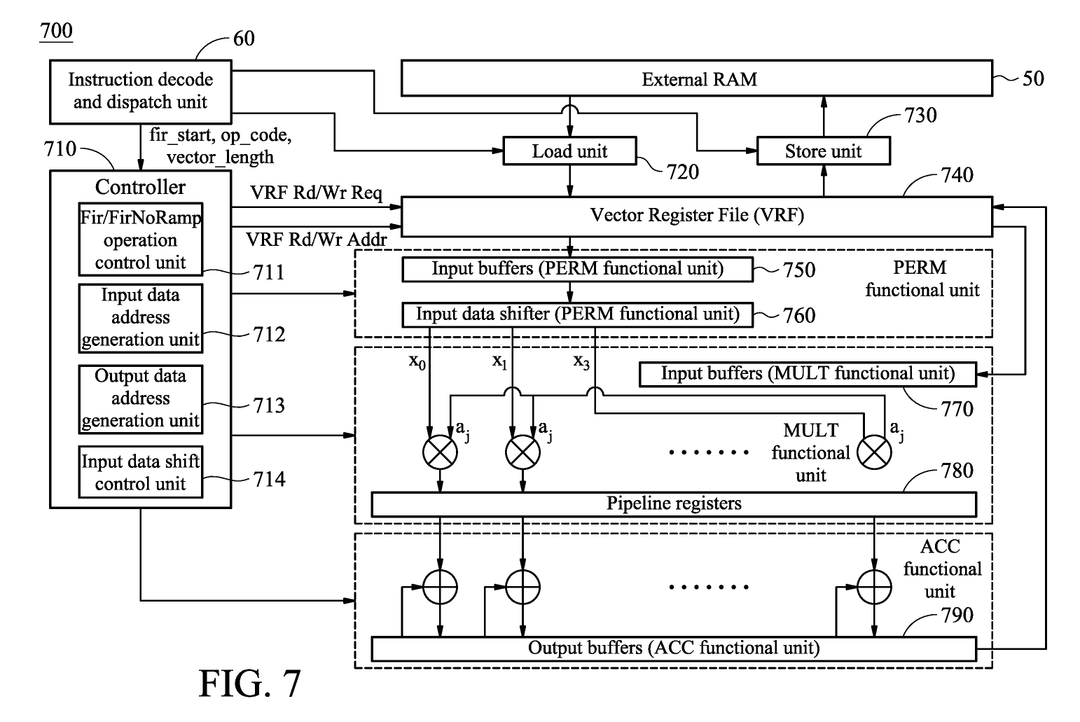

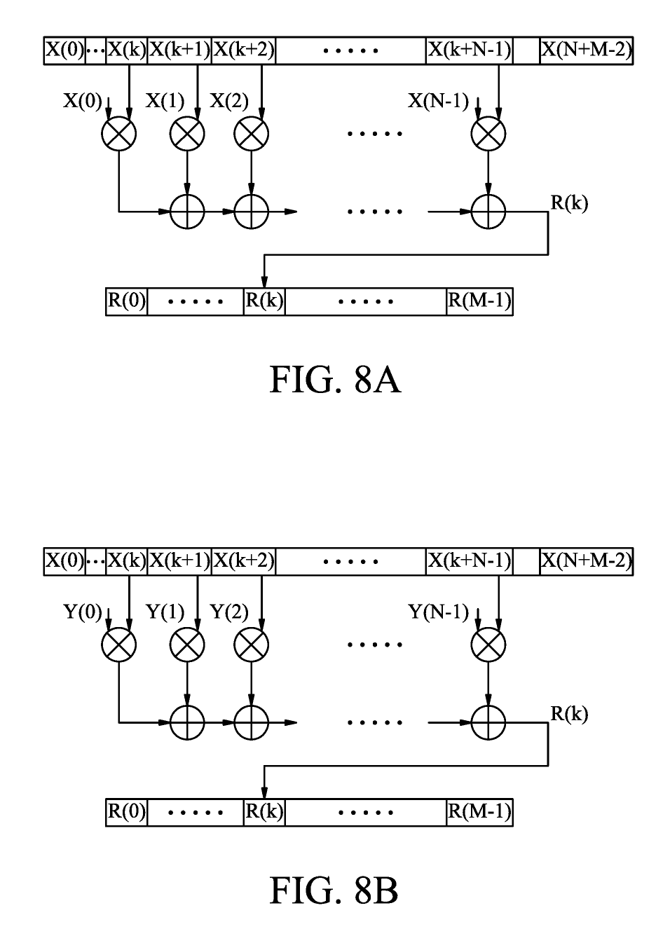

FIG. 8A is a schematic diagram showing the operation of auto-correlation according to an embodiment of the invention. FIG. 8B is a schematic diagram showing the operation of cross-correlation/vector multiplication according to an embodiment of the invention. The X(k) and Y(k) represent the input data, the R(k) represents the correlation/multiplication result.

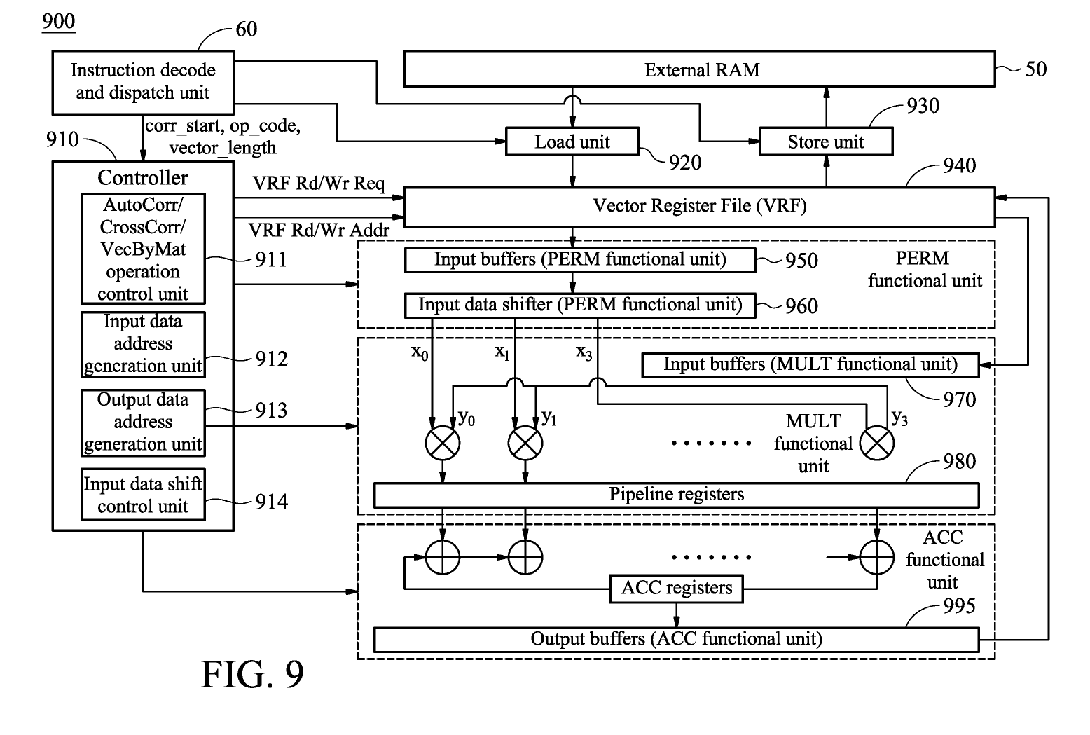

FIG. 9 shows an exemplary block diagram of a composite functional unit capable of performing the auto-correlation, cross-correlation/vector and multiplication operations according to an embodiment of the invention. Accompanying FIG. 8A and FIG. 8B with FIG. 9, the auto-correlation, cross-correlation and vector multiplication operations that can be carried out by the composite functional unit 900 are illustrated in more detail in the following paragraphs.

According to an embodiment of the invention, the ways to utilize the vector correlation related instructions are provided below:

AutoCorr Vr_dest, Vr_src1, Rctrl

CrossCorr Vr_dest, Vr_src1, Vr_src2, Rctrl

VecByMat Vr_dest, Vr_src1, Vr_src2, Rctrl

The AutoCorr is the instruction to support auto correlation of a data vector. The CrossCorr is the instruction to support cross-correlation of two data vectors. The VecByMat is the instruction to support the multiplication of a vector with a matrix, which can be realized as a simplified form of cross correlation of two data vectors when the Matrix is stored in a vector registers in either row-major or column-major format.

The input parameter Vr_dest is the name of a destination vector register that holds the output data, the input parameter Vr_src1 is the name of a source vector register that holds one data vector, the input parameter Vr_src2 is the name of a source vector register that holds one data vector (or a Matrix for the VecByMat instruction) and the input parameter Rctrl is the name of a control register used to specify the lengths of the input data vectors. The destination Vector register, source vector registers and control register are the register/vector registers in the multi-port register file unit 170.

As shown in FIG. 9, the instruction decode and dispatch unit 60 may decode the instructions received by the apparatus 100, and dispatch the decoded result to the corresponding functional unit. In this embodiment, the instruction decode and dispatch unit 60 may provide the control signals: corr_start, op_code and vector_length to the controller (the composite instruction controller) 910. The control signal corr_start indicates start of the corresponding operation. The control signal op_code indicates which operation of the auto-correlation, cross-correlation and vector multiplication is to be performed and further indicates the names of the registers to be accessed. The control signal vector_length indicates the length of the vector to be processed.

The input data is loaded from the external RAM 50 and then stored in the vector register file (VRF) 940 via the load unit 920. The output data is loaded from vector register file (VRF) 940 and then stored in the external RAM 50 via the store unit 930. It should be note that in FIG. 9, the load unit 920 represents a combination of the functions of the RAM load unit 150 and the lane load unit 185 for simplicity. Similarly, the store unit 930 represents a combination of the functions of the RAM store unit 160 and the lane store unit 180 for simplicity. The vector register file (VRF) 940 represents the vector registers, which are configured to facilitate performance of the FIR or FIR without ramping operation via the instruction, in the multi-port register file 170 for simplicity.

The correlation related instructions use hardware resources in multiplier, accumulation, and permutation functional units. The controller 910 is configured to generate control signals to conduct the data flow of the AutoCorr, CrossCorr and VecByMat instructions based on the operation procedures required by the auto-correlation, cross-correlation and vector multiplication algorithms. The controller 910 comprises an AutoCorr/CrossCorr/VecByMat operation control unit 911, an input data address generation unit 912, an output data address generation unit 913 and an input data shift control unit 914. The AutoCorr/CrossCorr/VecByMat operation control unit 911 is configured to issue the control signals for controlling the correlation operation flow for different instructions. The input data address generation unit 912 is configured to generate an input data address for fetching data from the vector register file (VRF) 940 (i.e. the multi-port register file unit) based on the register name carried in the control signal op_code and providing fetched data to the input buffers of the corresponding functional units. The output data address generation unit 913 is configured to generate an output data address for storing data fetched from the output buffers of the corresponding functional units to the vector register file (VRF) 940 (i.e. the multi-port register file unit) based on the register name carried in the control signal op_code. That is, the vector register file (VRF) 940 is configured to hold the source and destination data vector registers for the AutoCorr/CrossCorr/VecByMat instructions. The input data shift control unit 914 is configured to generate a plurality of shift control signals to shift input data vector for supporting the correlation algorithms.

The auto-correlation instruction (AutoCorr) is to calculate:

R(k)=Σⱼ₌₀^{N-1}x(k+j)x(j), k=0,1, . . . ,(M−1)

The cross-correlation instruction (CrossCorr) is to calculate:

R(k)=Σⱼ₌₀^{N-1}x(k+j)y(j), k=0,1, . . . ,(M−1)

The vector-by-matrix multiplication instruction (VecByMat) is to calculate (assuming x holds the matrix and y holds the vector):

R(k)=Σⱼ₌₀^{N-1}x(k*N+j)y(j), k=0,1, . . . ,(M−1)

The x(k) and y(j) represent the input data and the R(k) represents the calculation result, the N represents the length the input vector (or the number of rows of the input matrix, which can be the same as the size of the input vector), and the M represents the length of the output data vector (or the number of columns of the input matrix, which can be the same as the size of the output data vector).

The controller 910 issues the read request (e.g. the VRF Rd Req) and provides the read address (e.g. the VRF Rd Addr) to load the input data and the coefficients from the vector register file (VRF) 940 to the input buffers of the permutation functional units 140 (shown as the input buffers (PERM functional unit) 950 in FIG. 9) and the input buffers of the multiplier functional units 120 (shown as the input buffers (MULT functional unit) 970 in FIG. 9). The input data shifter of the permutation functional units 140 (shown as the input data shifter (PERM functional unit) 960 in FIG. 9) is configured to perform shift operation on the input data. The shifted input data is multiplied by the input data y(j) via the multiplier functional units 120 and the output data of the multiplier functional units 120 is then provided to the accumulation functional units 130 via the pipeline registers 980. The accumulation functional units 130 perform the cross-lane accumulation calculations on the received data via the cross-lane ACC registers 990. The calculation result is stored in the output buffers thereof (shown as the output buffers (ACC functional unit) 995 in FIG. 9). The output buffers inside the ACC functional units are configured to hold the output data to be saved back to vector register file (VRF) 940. The controller 910 issues the write request (e.g. the VRF Wr Req) and provides the write address (e.g. the VRF Wr Addr) to write the output data to the vector register file (VRF) 940.

It should be noted that in the embodiments of the invention, the AutoCorr/CrossCorr/VecByMat instructions can be executed in parallel with other normal (non-composite) instructions such as load and store instructions.

It should also be noted that in the architecture shown in FIG. 9, the composite functional unit 900 has a cross-lane architecture, that is, the accumulation functional units 130 is configured to perform the cross-lane accumulation calculations.

As discussed above, in the embodiments of the invention, a single composite instruction (such as an FFT, IFFT, FHT, Fir, FirNoRamp, AutoCorr, CrossCorr, VecByMat . . . ect.) can support a complex algorithm which was realized by software subroutine or micro-codes in the software solution design. It should be noted that unlike the software solution, in which a “function call” is created via combining multiple general-purpose instructions in the software subroutine or micro-codes, in the embodiments of the invention, a single composite instruction is implemented. For a “function call”, the software control overhead is the main drawback and the code size is large. On the contrary, for a composite instruction, there is no such software control overhead and code size problem since the VDSP users don't have to create any function by themselves and don't have to perform any further software codes or micro-codes programming, and can directly use the corresponding instruction to perform the corresponding calculation.

In addition, a composite instruction in VDSP can achieve the same performance of dedicated co-processor while sharing the same hardware resources in VDSP with other normal (non-composite) instructions.

Therefore, the technical effects and can may be achieved by this invention includes: 1) reduced software code size when using the composite instruction to realize common algorithms, as compared to the software solution, 2) better performance (higher data throughput) due to reduced control overhead, as compared to the software solution and 3) higher utilization of hardware resource, as compared to the co-processor solution.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An apparatus, comprising:
a plurality of signal processing lanes, each signal processing lane comprising:
a first fundamental functional unit;
a second fundamental functional unit; and
a register file unit, comprising a plurality of configurable vector registers; and
a composite instruction controller, coupled to the first fundamental functional units and the second fundamental functional units in the plurality of signal processing lanes, and is configured to issue a plurality of control signals in response to a composite instruction to control the first fundamental functional units and the second fundamental functional units and thereby carry out a composite operation.

2. The apparatus as claimed in claim 1, wherein each of the first fundamental functional unit and the second fundamental functional unit is capable of carrying out an operation selected from a group comprising an addition, a multiplication, an accumulation and a permutation.

3. The apparatus as claimed in claim 1, wherein the composite operation is selected from a group comprising a Fast Fourier Transform (FFT), an inverse Fast Fourier Transform (iFFT), a Fast Hadamard Transform (FHT), a Finite Impulse Response (FIR) filtering with ramping, an FIR filtering without ramping, an auto-correlation, a cross-correlation and a vector-by-matrix multiplication.

4. The apparatus as claimed in claim 1, wherein the composite instruction controller comprises:
an operation control unit, configured to issue the control signals;
an input data address generation unit, configured to generate an input data address for fetching data from the register file unit; and
an output data address generation unit, configured to generate an output data address for storing data to the register file unit.

5. The apparatus as claimed in claim 1, wherein at least part of the first fundamental functional units and the second fundamental functional units are controlled to carry out a butterfly operation.

6. The apparatus as claimed in claim 5, wherein the composite instruction controller further comprises:
an output data permutation control unit, configured to generate a plurality of permutation control signals for re-ordering data outputted from the butterfly operations.

7. The apparatus as claimed in claim 5, wherein the butterfly operation is a radix-2 butterfly operation or a radix-4 butterfly operation.

8. The apparatus as claimed in claim 4, wherein the composite instruction controller further comprises:
an input data shift control unit, configured to generate a plurality of shift control signals to shift an input data vector.

9. An apparatus, comprising:
a plurality of signal processing lanes, each signal processing lane comprising:
a first fundamental functional unit, comprising a plurality of first buffers and a first computation unit;
a second fundamental functional unit, comprising a plurality of second buffers and a second computation unit; and
a register file unit, comprising a plurality of configurable vector registers; and
a first composite instruction controller, configured to issue a plurality of control signals in response to a first composite instruction to control the plurality of first buffers and the first computation unit of the first fundamental functional units and the plurality of second buffers and the second computation unit of the second fundamental functional units in the plurality of signal processing lanes and thereby carry out a first composite operation.

10. The apparatus as claimed in claim 9, further comprising:
a second composite instruction controller, configured to issue a plurality of control signals in response to a second composite instruction to control the plurality of first buffers and the first computation unit of the first fundamental functional units and the plurality of second buffers and the second computation unit of the second fundamental functional units in the plurality of signal processing lanes and thereby carrying out a second composite operation.

11. The apparatus as claimed in claim 9, wherein each of the first fundamental functional unit and the second fundamental functional unit is capable of carrying out an operation selected from a group comprising an addition, a multiplication, an accumulation and a permutation.

12. The apparatus as claimed in claim 9, wherein the first composite operation is selected from a group comprising a Fast Fourier Transform (FFT), an inverse Fast Fourier Transform (iFFT), a Fast Hadamard Transform (FHT), a Finite Impulse Response (FIR) filtering with ramping, an FIR filtering without ramping, an auto-correlation, a cross-correlation and a vector-by-matrix multiplication.

13. The apparatus as claimed in claim 9, wherein the first composite instruction controller comprises:
an operation control unit, configured to issue the control signals;
an input data address generation unit, configured to generate an input data address for fetching data from the register file unit; and
an output data address generation unit, configured to generate an output data address for storing data to the register file unit.

14. The apparatus as claimed in claim 9, wherein at least part of the first fundamental functional units and the second fundamental functional units are controlled to carry out a butterfly operation.

15. The apparatus as claimed in claim 14, wherein the composite instruction controller further comprises:
an output data permutation control unit, configured to generate a plurality of permutation control signals for re-ordering data outputted from the butterfly operations.

16. The apparatus as claimed in claim 14, wherein the butterfly operation is a radix-2 butterfly operation or a radix-4 butterfly operation.

17. The apparatus as claimed in claim 13, wherein the composite instruction controller further comprises:
an input data shift control unit, configured to generate a plurality of shift control signals to shift an input data vector.
